(19) United States
(12) Patent Application Publication
(10) Pub. No.: US 2026/0021507 A1
(43) Pub. Date: Jan. 22, 2026

(54) HOT MELT ADHESIVE DISPENSING DEVICE AND PROCESS

(71) Applicant: SuZhou FSTW Electronic Technology CO.,LTD, Suzhou City (CN)

(72) Inventors: Hongguang Yu, Shenzhen City (CN); Leixiang Sun, Henan Province (CN); Weilong Zhao, Yuzhou City (CN); Shipeng Wu, Henan Province (CN)

(21) Appl. No.: 19/339,180

(22) Filed: Sep. 24, 2025

(30) Foreign Application Priority Data
Sep. 3, 2025 (CN) 202511252847.3

(51) Int. Cl. B05C 5/02; B05C 21/00

(52) U.S. Cl. CPC B05C 5/0225; B05C 21/00

(57) ABSTRACT

A hot melt adhesive dispensing device includes a bottom frame, wherein a lifting mechanism for controlling ascending and descending of an adhesive hose, a fixing assembly for fixing the adhesive hose is connected to the lifting mechanism, the fixing assembly includes a base, the base is connected to the lifting mechanism, a movable base is detachably mounted on the base, a mounting hole for mounting the adhesive hose is formed in the movable base, and a limiting groove for limiting a lug of the adhesive hose is formed in the movable base; and the bottom frame is provided with an adhesive discharge assembly, the adhesive discharge assembly includes an insertion rod for guiding and discharging adhesive, and the bottom frame is provided with a cooling assembly. In the application, improving the resource-saving effect of the hot melt adhesive dispensing device during use is achieved.

### TECHNICAL FIELD

The present application relates to the technical field of hot melt adhesive dispensing devices, in particular to a hot melt adhesive dispensing device and process.

### BACKGROUND

A hot melt adhesive is a plastic adhesive, its physical state changes with the temperature within a certain temperature range, while its chemical properties remain unchanged. The hot melt adhesive is non-toxic and tasteless and is an environmentally friendly chemical product. Because the product itself is a solid, the product is easy to package, transport, store, solvent-free, pollution-free, and non-toxic; and the hot melt adhesive is highly favored for its advantages such as a simple production process, a high added value, high bonding strength, and fast speed.

The hot melt adhesive needs to be melted before use. Therefore, a special hot melt adhesive melt injection device is usually required when the hot melt adhesive is used. A hot melt gun is usually used in the case of manual processing or in the case of assembly of some devices, while in the industrial production of bonding using exclusively the hot melt adhesive, a special adhesive dispensing device needs to be set, an adhesive inside is melted during dispensing, and then the adhesive is extruded through an extrusion device onto the surface of a product to be bonded.

A head of a conventional adhesive hose is usually provided with an adhesive outlet nozzle, and a tail of the conventional adhesive hose is provided with a lug, a piston pusher is mounted near the tail inside the adhesive hose, a conventional hot melt device heats a whole hose of adhesive at one time, and then the pusher is extruded from the tail of the adhesive hose to the head of the adhesive hose for adhesive discharge. However, the adhesive is deteriorated after being heated and solidified again and cannot be used again, and when the adhesive is not used after once heating or is not used after the solidification time, the whole hose of adhesive is deteriorated and cannot be used, which can easily result in significant waste. Such adhesive is expensive, thus causing greater costs.

### SUMMARY

In order to improve the resource-saving effect of a hot melt adhesive dispensing device and process during use, the present application provides a hot melt adhesive dispensing device and process.

The present application provides a hot melt adhesive dispensing device and process, and adopts the following technical solutions:
a hot melt adhesive dispensing device includes a bottom frame, wherein a lifting mechanism for controlling ascending and descending of an adhesive hose is mounted on the bottom frame, a fixing assembly for fixing the adhesive hose is connected to the lifting mechanism, the fixing assembly includes a base, the base is connected to the lifting mechanism, a movable base is detachably mounted on the base, a mounting hole for mounting the adhesive hose is formed in the movable base, and a limiting groove for limiting a lug of the adhesive hose is formed in the movable base; and the bottom frame is provided with an adhesive discharge assembly, and the adhesive discharge assembly includes an insertion rod inserted into the adhesive hose to guide and discharge an adhesive, the insertion rod is mounted on the bottom frame, and the bottom frame is provided with a cooling assembly for cooling the adhesive hose.

By adopting the above technical solution, the fixing assembly realizes stable mounting and detachable fixing of the adhesive hose, facilitating replacement and maintenance of the adhesive hose; the lifting mechanism drives the adhesive hose to ascend and descend, facilitating precise abutting joint of the adhesive hose with the adhesive discharge assembly; flow guide is performed in the adhesive discharge assembly by inserting the insertion rod into the adhesive hose, changing the traditional method of adhesive discharge through extrusion, and improving the stability of adhesive discharge; and the cooling assembly can cool a specific area of the adhesive hose, so that a heating area is only formed in an area between the cooling assembly and the fixing assembly for the adhesive hose, achieving on-demand heating, avoiding adhesive waste caused by whole hose heating, and at the same time, reducing heating energy consumption and improving heating efficiency.

In a specific embodiment, the adhesive discharge assembly further includes a piezoelectric injection valve, the piezoelectric injection valve is mounted on the bottom frame, the piezoelectric injection valve is provided with an adhesive outlet hole and a flow guide channel, and the adhesive outlet hole communicates with the flow guide channel; and a connecting base is mounted on the piezoelectric injection valve, the connecting base is provided with a positioning cylinder, the positioning cylinder is provided with the insertion rod, the insertion rod is provided with a main flow passage, the main flow passage communicates with the flow guide channel of the piezoelectric injection valve, an end, inserted into the adhesive hose, of the insertion rod is provided with secondary flow passages, and the secondary flow passages communicate with the main flow passage.

By adopting the above technical solution, the piezoelectric injection valve cooperates with the connecting base to achieve stable mounting of the insertion rod, and the positioning cylinder further positions the insertion rod to ensure the coaxiality when the insertion rod is in abutting joint with the adhesive hose; the main flow passage and the secondary flow passages in the insertion rod form a complete flow guide passage, and the secondary flow passages are formed at one end, inserted into the adhesive hose, of the insertion rod, and can be in direct contact with the molten hot melt adhesive, and the molten adhesive passes through the secondary flow passages, the main flow passage, and the flow guide channel in sequence, and is ejected out from the adhesive outlet hole, and a flow guide path is clear and the scaling performance is good, so as to avoid waste caused by adhesive leakage while ensuring the uniformity and stability of adhesive discharge.

In a particular embodiment, the cooling assembly includes a fixed plate, the fixed plate is mounted on the bottom frame, the fixed plate is provided with a sliding slot, the fixed plate is slidably provided with a slider through the sliding slot, the slider is locked on the fixed plate by bolts, the slider is provided with a connecting plate, and the connecting plate is provided with a refrigerating module for cooling the adhesive hose.

By adopting the above technical solution, the fixed plate provides a mounting basis for the cooling assembly, and the slider can slide along the sliding slot, realizing the position adjustment of the refrigerating module in the vertical direction, so as to change the length of the heating area, satisfying the requirements of different adhesive discharge amounts; the slider is locked by the bolts to ensure stability after adjusting the position of the refrigerating module, avoiding position deviation due to vibration and the like; and the connecting plate realizes the connection of the refrigerating module to the slider, and the refrigerating module can rapidly cool the corresponding area of the adhesive hose, so that the adhesive in this area is kept solid, only the adhesive in the heating area is melted, precisely controlling the heating range, and further reducing adhesive waste.

In a particular embodiment, the base is provided with an insertion slot, the base is provided with a bottom platform, the movable base is provided with an insertion connector inserted into the insertion slot, and the insertion connector is provided with a first positioning plate abutting against the base.

By adopting the above technical solution, the insertion slot cooperates with the insertion connector to realize the detachable connection of the movable base and the base, the structure is simple and the mounting is convenient; and the first positioning plate can quickly position the mounting position of the movable base, and when the first positioning plate abuts against the base, the movable base reaches a preset mounting position without additional measurement and positioning, and the mounting efficiency is improved, and at the same time, the consistency of the mounting position of the movable base is ensured, and the precision of the abutting joint of the adhesive hose with the adhesive discharge assembly is ensured.

In a specific embodiment, supporting rods are mounted on the base, a first guide rod is mounted on the supporting rods, a lifting plate is slidably mounted on the supporting rods, each supporting rod is sleeved with a first spring, one end of each first spring is connected with the lifting plate, and the other end of the first spring is connected with the first guide rod; and fixed rods arc mounted on the lifting plate, a second guide rod is mounted on each fixed rod, a fastening plate for fastening the lug of the adhesive hose is slidably mounted on each second guide rod, each second guide rod is sleeved with a second spring, one end of each second spring is connected with the corresponding fastening plate, and the other end of the second spring is connected with the corresponding fixed rod, and pull rods for controlling the movement of the fastening plates are connected to the base.

By adopting the above technical solution, when the adhesive hose is mounted, the lug of the adhesive hose presses the lifting plate, and the first springs are deformed to provide a pre-tightening force for subsequent fastening of the lug by the fastening plates; the fixed rods cooperate with the second guide rods to achieve sliding mounting of the fastening plates, and the fastening plates can tightly fasten the lug; and the pull rods control the opening and closing of the fastening plates, further improving the stability of adhesive hose fixation, and preventing the adhesive hose from rotating or falling off during the lifting or adhesive discharge process.

In a particular embodiment, sliding rods are slidably mounted on the base, ends of the sliding rods are provided with a pressing buckle, ends, away from the pressing buckle, of the sliding rods are provided with a pressing plate, each sliding rod is sleeved with a third spring, one end of each third spring is connected with the pressing plate, and the other end of the third spring is connected with the base, moving blocks are slidably mounted on the first guide rod, each moving block is hinged with a hinge rod, one end, away from the corresponding moving block, of each hinge rod is hinged with the pressing plate, and each pull rod is mounted on the corresponding moving block.

By adopting the above technical solution, the sliding rods are matched with the pressing buckle, and when the movable base is mounted on the base, the movable base presses the pressing buckle to drive the sliding rods and the pressing plate to move; the third springs provide a restoring clastic force for the sliding rods, ensuring that the pressing buckle can be restored to the initial position after the movable seat is disassembled; and the moving blocks cooperate with the hinge rods to convert the linear motion of the pressing plate into the lateral motion of the moving blocks, and then the opening and closing of the fastening plates are controlled by the pull rods to realize the linkage between the mounting and fixation of the adhesive hose, simplifying the operation steps, and improving the convenience of use of the device, and at the same time ensuring a uniform and stable fastening force of the fastening plates to the lug of the adhesive hose.

In a particular embodiment, the insertion slot is a dovetail slot, and the insertion connector is a dovetail head.

By adopting the above technical solution, the cooperation of the dovetail slot with the dovetail head has good guidance and positioning accuracy, which can effectively prevent the movable base from deviating in the horizontal direction, while improving the stability of the connection between the movable base and the base, preventing the movable base from loosening during the operation of the device, ensuring that the adhesive hose is always in a preset working position, and ensuring the adhesive discharge accuracy and the adhesive dispensing quality.

In a particular embodiment, one end, inserted into the adhesive hose, of the insertion rod is disposed in the shape of a ball head.

By adopting the above technical solution, the ball-head-shaped design can reduce the resistance when the insertion rod is inserted into the adhesive hose, avoid damage to the internal structure of the adhesive hose, and at the same time, facilitate the quick and accurate insertion of the insertion rod into the adhesive hose, improving the efficiency of the abutting joint of the adhesive hose with the adhesive discharge assembly; and in addition, the ball-head-shaped structure can also reduce the residue of the adhesive at the end of the insertion rod, further reducing adhesive waste and reducing the difficulty of cleaning.

In a particular embodiment, the insertion rod is provided with a scaling ring.

By adopting the above technical solution, the scaling ring can enhance the sealing between the insertion rod and an inner wall of the adhesive hose, and prevent the molten hot adhesive from leaking from a gap between the insertion rod and the adhesive hose, avoiding adhesive waste and environmental pollution, while ensuring stable pressure inside the adhesive hose, ensuring uniform adhesive discharge, and improving the stability of the adhesive dispensing quality.

A hot melt adhesive dispensing process includes the steps of:
mounting an adhesive hose, namely mounting the adhesive hose on a fixing assembly;
connecting the adhesive hose with an adhesive discharge assembly, namely forming an opening in a tail end of the adhesive hose, and connecting the adhesive discharge assembly into the adhesive hose from the tail end of the adhesive hose;
mounting a cooling assembly, adjusting a cooling position of the cooling assembly to the adhesive hose, and taking an area between the cooling position of the cooling assembly and the fixing assembly as a heating area; and
heating the adhesive hose to melt a hot melt adhesive to be discharged.

By adopting the above technical solution, in the process, the height of the refrigerating module is adjusted by the critical step of positioning the heating area by the cooling assembly, and the area between the cooling assembly and the fixing assembly is taken as the heating area, breaking the conventional mode of whole hose heating: only part of the hot melt adhesive that needs to be used is melted in the heating area, and the hot melt adhesive in a cooling area remains solid and does not deteriorate; and the problem that a whole hose of adhesive is discarded due to solidification and deterioration of the unused adhesive after heating in the traditional process is avoided, particularly for a hot melt adhesive with higher cost, the loss of raw materials can be greatly reduced, and the resource-saving objective of on-demand heating and on-demand use can be directly achieved.

In summary, the present application includes at least one of the following beneficial technical effects:
1. The fixing assembly realizes stable mounting and detachable fixing of the adhesive hose, facilitating replacement and maintenance of the adhesive hose; the lifting mechanism drives the adhesive hose to ascend and descend, facilitating precise abutting joint of the adhesive hose with the adhesive discharge assembly; flow guide is performed in the adhesive discharge assembly by inserting the insertion rod into the adhesive hose, changing the traditional method of adhesive discharge through extrusion, and improving the stability of adhesive discharge; and the cooling assembly can cool a specific area of the adhesive hose, so that a heating area is only formed in an area between the cooling assembly and the fixing assembly for the adhesive hose, achieving on-demand heating, avoiding adhesive waste caused by whole hose heating, and at the same time, reducing heating energy consumption and improving heating efficiency; and
2. In the process, the height of the refrigerating module is adjusted by the critical step of positioning the heating area by the cooling assembly, and the area between the cooling assembly and the fixing assembly is taken as the heating area, breaking the conventional mode of whole hose heating: only part of the hot melt adhesive that needs to be used is melted in the heating area, and the hot melt adhesive in a cooling area remains solid and does not deteriorate; and the problem that a whole hose of adhesive is discarded due to solidification and deterioration of the unused adhesive after heating in the traditional process is avoided, particularly for a hot melt adhesive with higher cost, the loss of raw materials can be greatly reduced, and the resource-saving objective of on-demand heating and on-demand use can be directly achieved.

### BRIEF DESCRIPTION OF DRAWINGS

FIG. 1 is a schematic diagram of a hot melt adhesive dispensing device according to an embodiment of the present application.

FIG. 2 is a schematic diagram of a lift mechanism according to an embodiment of the present application.

FIG. 3 is a schematic diagram of a base according to an embodiment of the present application.

FIG. 4 is a schematic diagram of a movable base according to an embodiment of the present application.

FIG. 5 is a schematic diagram in which the movable base is mounted on the base according to an embodiment of the present application.

FIG. 6 is a cross-sectional view of the base according to an embodiment of the present application.

FIG. 7 is a schematic diagram of an adhesive discharge assembly according to an embodiment of the present application.

FIG. 8 is a cross-sectional view of the adhesive discharge assembly according to an embodiment of the present application.

FIG. 9 is a schematic diagram of a cooling assembly according to an embodiment of the present application.

Reference numerals: 1, bottom frame; 2, lifting mechanism; 21, cylinder; 22, mounting plate; 3, fixing assembly; 31, base; 311, insertion slot; 312, bottom platform; 313, first threaded hole; 314, closing slot; 32, movable base; 321, insertion connector; 322, first positioning plate; 323, locking hole; 324, mounting hole; 325, limiting groove; 326, second positioning plate; 331, supporting rod; 332, lifting plate; 333, first spring; 334, fixed rod; 335, second guide rod; 336, fastening plate; 337, second spring; 341, sliding rod; 342, pressing buckle; 343, pressing plate; 344, third spring; 345, hinge rod; 346, first guide rod; 347, moving block; 348, pull rod; 4, adhesive discharge assembly; 41, piezoelectric injection valve; 42, connecting base; 43, positioning cylinder; 44, insertion rod; 441, secondary flow passage; 442, main flow passage; 443, scaling ring; 5, cooling assembly; 51, fixed plate; 511, sliding slot; 52, slider; 53, connecting plate; and 54, refrigerating module.

### DESCRIPTION OF THE EMBODIMENTS

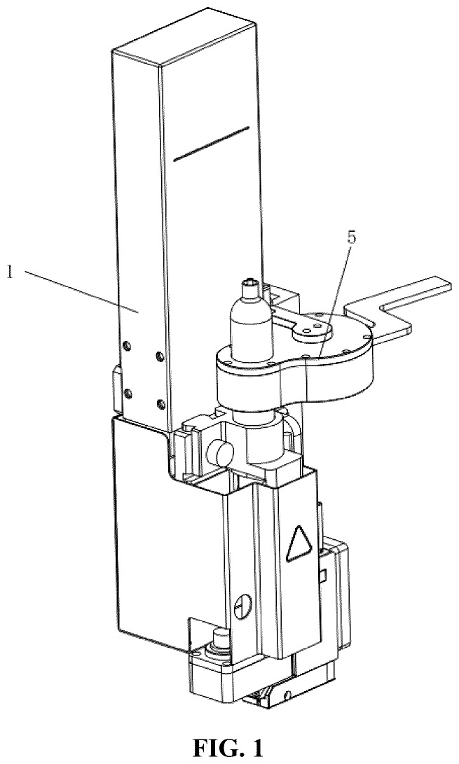

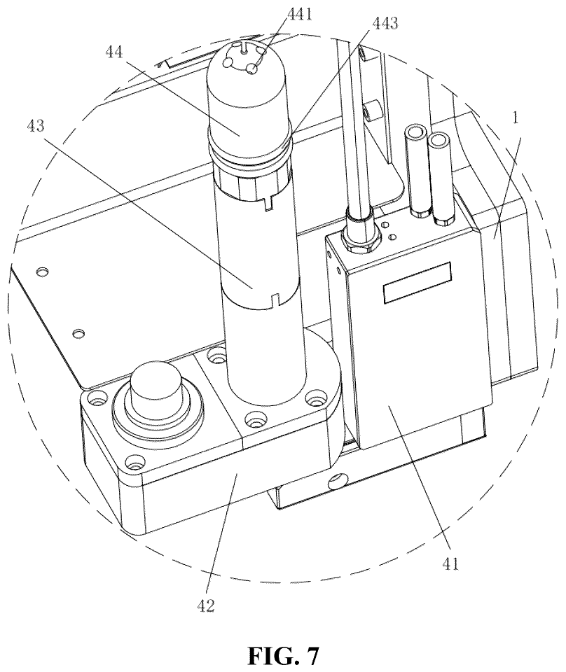

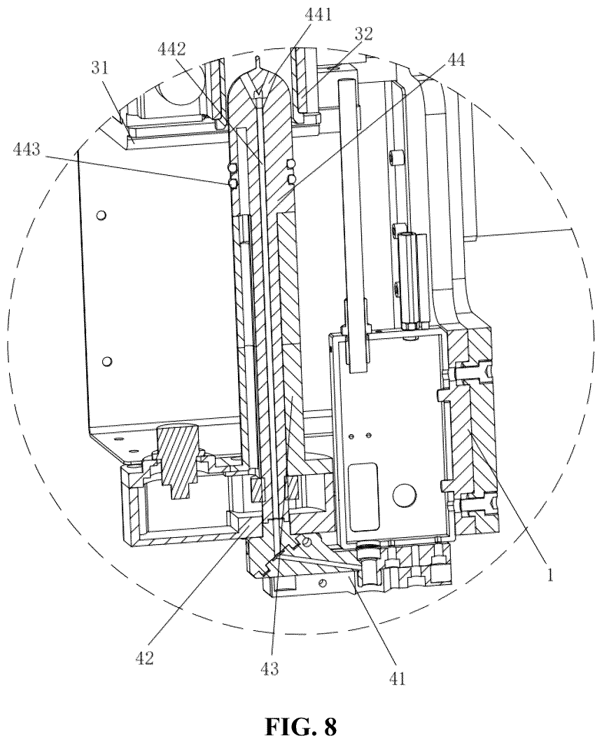

The present application is further described in detail below with reference to FIGS. 1 to 9.

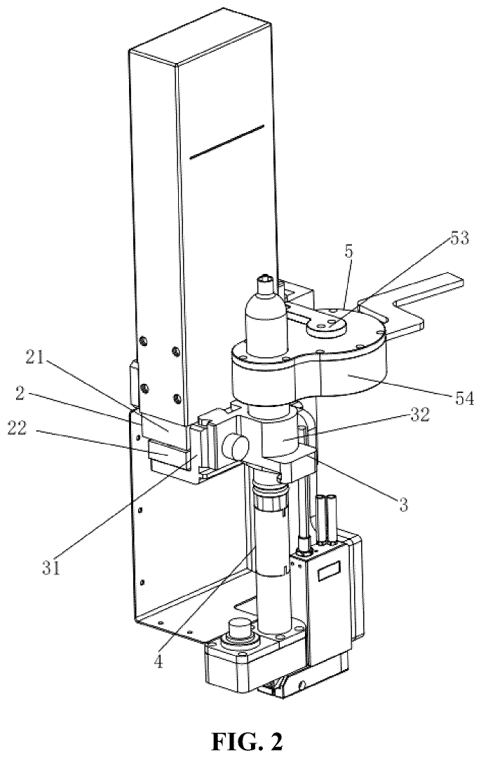

An embodiment of the present application discloses a hot melt adhesive dispensing device and process. Referring to FIGS. 1 and 2, the device includes a bottom frame 1, a lifting mechanism 2 for controlling the movement of an adhesive hose is mounted on the bottom frame 1, a fixing assembly 3 for fixing the adhesive hose is connected to the lifting mechanism 2, an adhesive discharge assembly 4 inserted into the adhesive hose is mounted on the bottom frame 1, and a cooling assembly 5 for cooling the adhesive hose is mounted on the bottom frame 1.

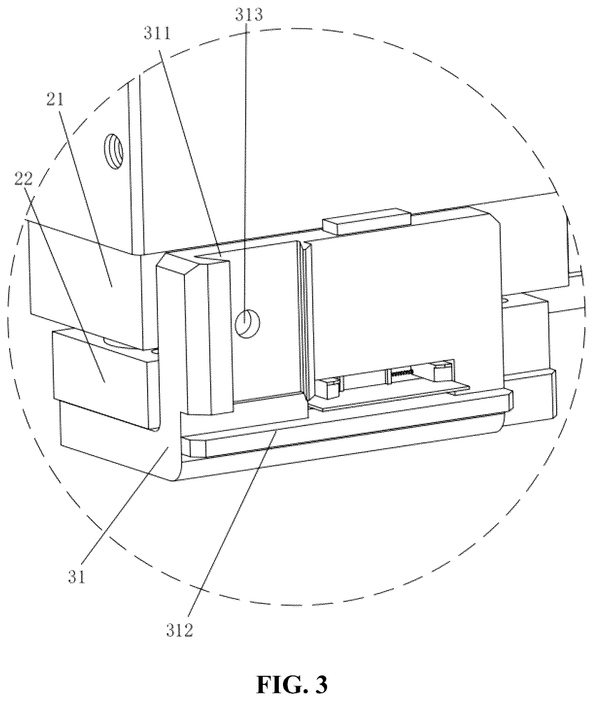

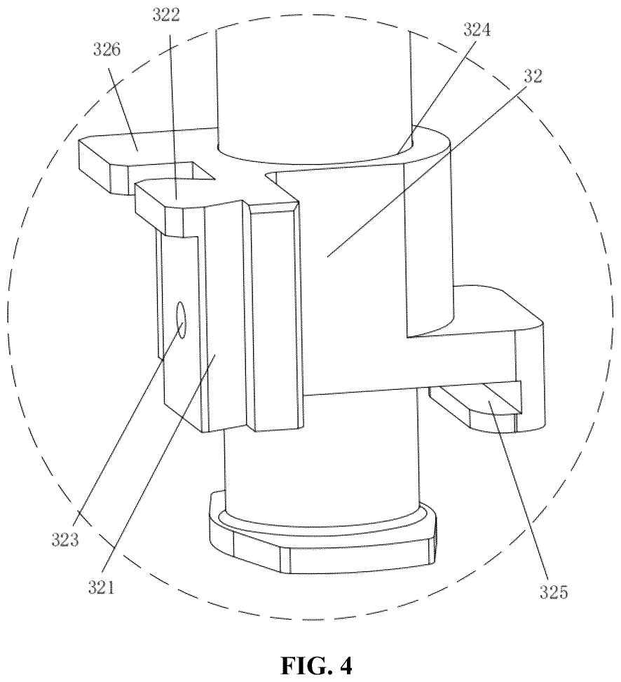

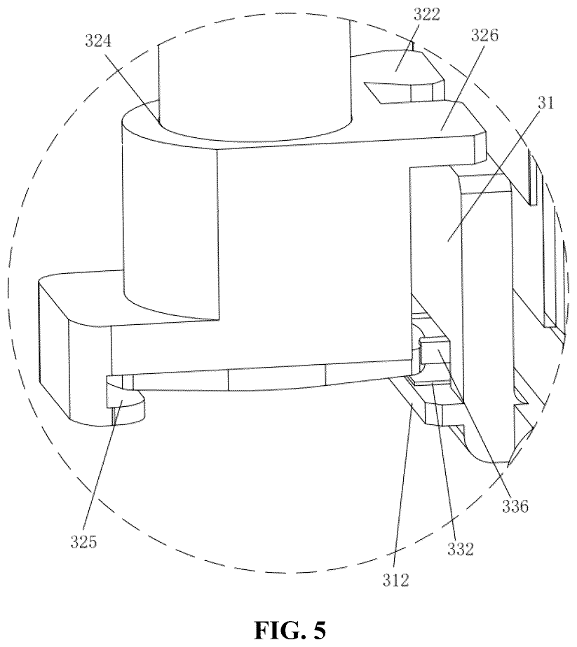

The lifting mechanism 2 is a cylinder 21, the cylinder 21 is fixedly mounted on the bottom frame 1, and an output shaft of the cylinder 21 is fixedly provided with a mounting plate 22. In an embodiment of the present application, the lifting mechanism 2 can also use a known prior art such as a motor, an electric slide table or a pneumatic slide table. Referring to FIG. 3, FIG. 4 and FIG. 5, the fixing assembly 3 includes a base 31, the base 31 is fixedly mounted on the mounting plate 22, an insertion slot 311 is formed in the base 31, the insertion slot 311 is a dovetail slot, a first threaded hole 313 is formed in the base 31, and the first threaded hole 313 communicates with the insertion slot 311; and a bottom platform 312 is fixedly installed on the base 31, and the bottom platform 312 is disposed below the insertion slot 311. The base 31 is detachably provided with a movable base 32 through the insertion slot 311, and the movable base 32 includes an insertion connector 321 inserted into the insertion slot 311. The insertion connector 321 is a dovetail head matched with the insertion slot 311. A first positioning plate 322 is integrally formed on the insertion connector 321. The insertion connector 321 is provided with a locking hole 323 aligned with the first threaded hole 313. The movable base 32 is provided with a mounting hole 324 for mounting the adhesive hose, and a limiting groove 325 for limiting a lug of the adhesive hose.

As shown in FIGS. 2 and 4, an adhesive hose is mounted on the movable base 32. In an embodiment of the present application, a head end of the adhesive hose is provided with an adhesive outlet nozzle, and a tail end of the adhesive hose is provided with a lug, and both the head end and the tail end of the adhesive hose are closed, and when the adhesive hose is mounted, the head end of the adhesive hose is inserted into the mounting hole 324 from a position below the movable base 32, and after the adhesive hose is inserted into the movable base 32, the adhesive hose is rotated so that the lug of the adhesive hose is rotated into the limiting groove 325 to prevent the adhesive hose from falling off from the movable base 32. Then, the insertion connector 321 of the movable base 32 is inserted into the insertion slot 311 from a position above the base 31. When the first positioning plate 322 abuts against the base 31, the locking hole 323 in the movable base 32 is aligned with the first threaded hole 313, and then a bolt is screwed into the first threaded hole 313 to lock the movable base 32 on the base 31.

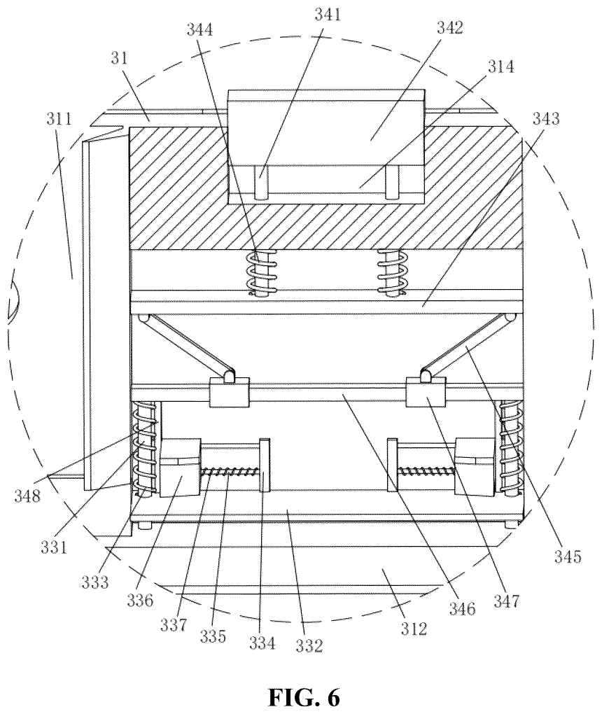

Referring to FIGS. 5 and 6, the base 31 is fixedly provided with supporting rods 331, a first guide rod 346 is fixedly mounted on the supporting rods 331, a lifting plate 332 is slidably mounted on the supporting rods 331, each supporting rod 331 is sleeved with a first spring 333, one end of each first spring 333 is fixedly connected with the lifting plate 332, and the other end of the first spring 333 is fixedly connected with the first guide rod 346. The lifting plate 332 is provided with two sets of fastening assemblies for fastening the lug of the adhesive hose, each fastening assembly includes a fixed rod 334 fixedly mounted on the lifting plate 332, a second guide rod 335 is fixedly mounted on each fixed rod 334, a fastening plate 336 for fastening the lug of the adhesive hose is slidably mounted on each second guide rod 335, each second guide rod 335 is sleeved with a second spring 337, one end of each second spring 337 is fixedly connected with the corresponding fastening plate 336, and the other end of the second spring 337 is fixedly connected with the corresponding fixed rod 334.

A closing slot 314 is formed in the base 31, sliding rods 341 are slidably mounted on the base 31, one end of each sliding rod 341 is extended into the closing slot 314, a pressing buckle 342 is fixedly installed on ends, extended into the closing slot 314, of the sliding rods 341, a second positioning plate 326 for pressing the pressing buckle 342 is integrally formed on the movable base 32, and the second positioning plate 326 is disposed parallel to the first positioning plate 322. A pressing plate 343 is fixedly installed at ends, away from the pressing buckle 342, of the sliding rods 341, each sliding rod 341 is sleeved with a third spring 344, one end of each third spring 344 is fixedly connected with the pressing plate 343, and the other end of the third spring 344 is fixedly connected with the base 31. Two moving blocks 347 are slidably connected to the first guide rod 346, each moving block 347 is hinged with a hinge rod 345, one end, away from the corresponding moving block 347, of each hinge rod 345 is hinged with a bottom surface of the pressing plate 343, the two hinge rods 345 are in an inverted V-shaped state, each pull rod 348 for pushing the corresponding fastening plate 336 to move is fixedly mounted on the corresponding moving block 347, each pull rod 348 is an L-shaped rod, one end of each pull rod 348 is fixedly connected to the corresponding moving block 347, and the other end of the pull rod 348 is extended to a position below the corresponding fastening plate 336 from sides, away from each other, of the two fastening plates 336.

When the movable base 32 is mounted on the base 31, the lug of the adhesive hose is in contact with the lifting plate 332 and is located between the two fastening plates 336. When the lug is in contact with the lifting plate 332, the second positioning plate 326 is also in contact with the pressing buckle 342. When the movable base 32 continues to move downward on the base 31, the lug presses the lifting plate 332 to slide downward on the supporting rods 331, the second positioning plate 326 presses the pressing buckle 342 into the closing slot 314, the pressing buckle 342 drives the pressing plate 343 to move downward, the pressing plate 343 pushes the hinge rods 345 to rotate, the hinge rods 345 push the two moving blocks 347 close to each other, the two moving blocks 347 drive the pull rods 348 close to each other, and the pull rods 348 push the fastening plates 336 close to each other to fasten the lug of the adhesive hose, thereby fixing and limiting the lug, enhancing the stability of the adhesive hose, and preventing the adhesive hose from rotating and falling out of the movable base 32 during use.

Referring to FIGS. 2, 7 and 8, the adhesive discharge assembly 4 includes a piezoelectric injection valve 41, and the piezoelectric injection valve 41 is fixedly mounted on the bottom frame 1. In the embodiments of the present application, the piezoelectric injection valve 41 is also referred to as a dispensing injection valve, the piezoelectric injection valve 41 is a prior art, and the structure and working principle of the piezoelectric injection valve 41 will not be described in the embodiments of the present application. An adhesive outlet hole and a flow guide channel are formed in the piezoelectric injection valve 41, the flow guide channel communicates with the adhesive outlet hole, a connecting base 42 is fixedly mounted on the piezoelectric injection valve 41, a positioning cylinder 43 is fixedly mounted on the connecting base 42, an insertion rod 44 inserted into the adhesive hose is fixedly mounted on the positioning cylinder 43, a main flow passage 442 is formed in the insertion rod 44, an end, close to the piezoelectric injection valve 41, of the insertion rod 44 abuts against the piezoelectric injection valve 41, and the main flow passage 442 communicates with the flow guide channel of the piezoelectric injection valve 41, an end, away from the piezoelectric injection valve 41, of the insertion rod 44 is disposed in the shape of a ball head and is provided with four secondary flow passages 441, each of the four secondary flow passages 441 communicates with the main flow passage 442, and a scaling ring 443 is embedded in the insertion rod 44.

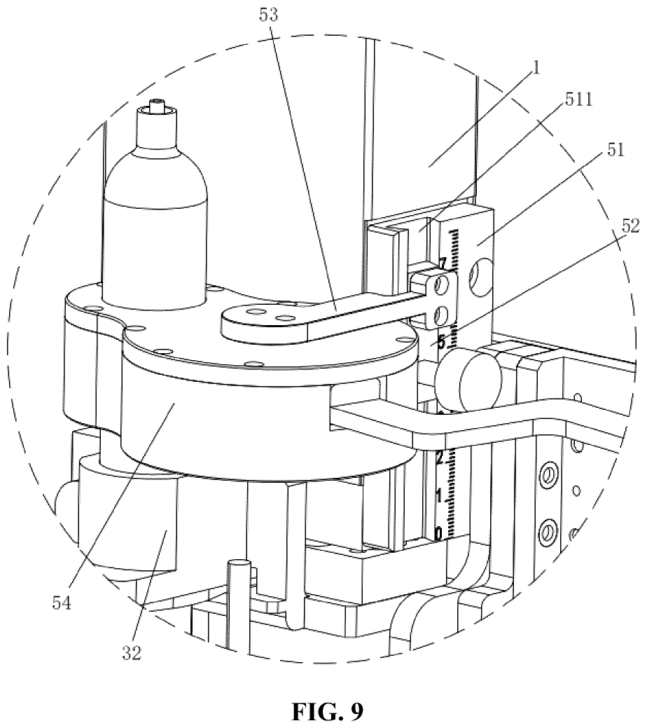

Referring to FIGS. 2 and 9, the cooling assembly 5 includes a fixed plate 51, the fixed plate 51 is fixedly mounted on the bottom frame 1, scales are printed on the fixed plate 51, a sliding slot 511 is formed in the fixed plate 51, the sliding slot 511 is also a dovetail slot, the fixed plate 51 is slidably provided with a slider 52 through the sliding slot 511, a cross section of the slider 52 is dovetail-shaped, a threaded hole is formed in the slider 52, and the slider 52 is fastened on the fixed plate 51 by screwing a bolt into the threaded hole, and fastening the bolt to the fixed plate 51. A connecting plate 53 is fixedly mounted on the slider 52. A refrigerating module 54 is fixedly mounted on the connecting plate 53. The refrigerating module 54 uses a semiconductor refrigerating technology, which is a purchased prior art. The refrigerating module 54 will not be described in the embodiments of the present application.

During adhesive dispensing, the tail end of the adhesive hose is opened, the cylinder 21 controls the adhesive hose to move downward so that the insertion rod 44 is inserted into the adhesive hose from the tail end of the adhesive hose, the refrigerating module 54 is mounted above the movable base 32, the adhesive hose is inserted into the refrigerating module 54, the bolt fixing the slider 52 is loosened, the position of the slider 52 on the fixed plate 51 is adjusted, the height of the refrigerating module 54 on the adhesive hose is determined, between the lower part of the refrigerating module 54 and the movable base 32 is a heating area, after leaving the height of the hot melt adhesive that needs to be heated, the refrigerating module 54 is fixed, and the area between the refrigerating module 54 and the movable base 32 and the area between the connecting base 42 and the movable base 32 are then heated. In the embodiments of the present application, a heating method of the hot melt adhesive is not limited, and it is preferable to use an electric heating rod for heating. After heating to melt the hot melt adhesive, the hot melt adhesive passes through the secondary flow passages 441 in the insertion rod 44, flows into the main flow passage 442, and then flows into the flow guide channel of the piezoelectric injection valve 41, and finally the piezoelectric injection valve 41 controls the hot melt adhesive to be dispensed from the adhesive outlet hole, and during heating, the cylinder 21 can control the adhesive hose to move downward so that the insertion rod 44 is slowly inserted into the adhesive hose, increasing the pressure in the adhesive hose, so that the hot melt adhesive smoothly flows out of the insertion rod 44.

An embodiment of the present application further provides an adhesive dispensing process, completed by the above adhesive dispensing device, including the following steps:
Step 1: an adhesive hose is mounted, namely one end, provided with an adhesive outlet nozzle, of the adhesive hose is mounted on a movable base 32 toward a position above the movable base 32, the movable base 32 is mounted on a base 31, and the adhesive hose and the movable base 32 are fixed;
Step 2: the adhesive hose and an insertion rod 44 are connected, an opening is formed in one end, away from the adhesive outlet nozzle, of the adhesive hose, and a cylinder 21 controls the adhesive hose to move downward so that a tail end of the adhesive hose is inserted into the insertion rod 44;
Step 3: the adhesive melting amount is determined, the refrigerating position of a refrigerating module 54 is determined, the refrigerating module 54 is mounted on a bottom frame 1 and mounted above the movable base 32, an area between the refrigerating module 54 and the movable base 32 is taken as a heating area, and the height of the refrigerating module 54 is adjusted to determine the refrigerating position of the adhesive hose; and
Step 4: heating and adhesive discharge are performed, namely the adhesive hose area between the refrigerating module 54 and the movable base 32 is heated to melt a hot melt adhesive inside the adhesive hose to flow from secondary flow passages 441 in the insertion rod 44 into a primary flow passage 442; and at the same time, the insertion rod 44 below the movable base 32 is also heated, and the heating method preferably adopts an electric heating rod.

The implementation principle of the embodiments of the present application is as follows: the adhesive hose is preliminarily fixed by using the mounting hole 324 and the limiting groove 325 of the movable base 32, and then precise positioning of the movable base 32 and the base 31 is realized by abutting joint of the dovetail slot and bolt locking, and at the same time, the fastening plates 336 are triggered to ensure stable mounting and uniform position of the adhesive hose; after the tail end of the adhesive hose is opened, the adhesive hose is driven to move downward by the lifting mechanism 2, so that the insertion rod 44 is inserted into the adhesive hose, the slider 52 of the cooling assembly 5 slides to adjust the height of the refrigerating module 54, and the heating area is determined by the distance between the refrigerating module 54 and the movable base 32, and the refrigerating module 54 is isolated from the unheated area after bolts are locked, so as to achieve the temperature control objective that only the heated part is melted; and the adhesive hose heating area and the insertion rod 44 are heated, ensuring that the adhesive is sufficiently melted and the flow guide channel is unobstructed; and slowly moving down the adhesive hose by the lifting mechanism 2 increases the internal pressure, and the molten adhesive is pushed to flow out along the secondary flow passages 441, the main flow passage 442, the flow guide channel, and the adhesive outlet hole to complete stable adhesive dispensing.

The above are preferred embodiments of the present application and are not intended to limit the scope of protection of the present application. Therefore, all equivalent variations made according to the structure, shape, and principle of the present application should be included in the scope of protection of the present application.

What is claimed is:

1. A hot melt adhesive dispensing device, comprising a bottom frame, wherein a lifting mechanism for controlling ascending and descending of an adhesive hose is mounted on the bottom frame, a fixing assembly for fixing the adhesive hose is connected to the lifting mechanism, the fixing assembly comprises a base, the base is connected to the lifting mechanism, a movable base is detachably mounted on the base, a mounting hole for mounting the adhesive hose is formed in the movable base, and a limiting groove for limiting a lug of the adhesive hose is formed in the movable base; and the bottom frame is provided with an adhesive discharge assembly, and the adhesive discharge assembly comprises an insertion rod inserted into the adhesive hose to guide and discharge an adhesive, the insertion rod is mounted on the bottom frame, and the bottom frame is provided with a cooling assembly for cooling the adhesive hose.

2. The hot melt adhesive dispensing device according to claim 1, wherein the adhesive discharge assembly further comprises a piezoelectric injection valve, the piezoelectric injection valve is mounted on the bottom frame, the piezoelectric injection valve is provided with an adhesive outlet hole and a flow guide channel, and the adhesive outlet hole communicates with the flow guide channel; and a connecting base is mounted on the piezoelectric injection valve, the connecting base is provided with a positioning cylinder, the positioning cylinder is provided with the insertion rod, the insertion rod is provided with a main flow passage, the main flow passage communicates with the flow guide channel of the piezoelectric injection valve, an end, inserted into the adhesive hose, of the insertion rod is provided with secondary flow passages, and the secondary flow passages communicate with the main flow passage.

3. The hot melt adhesive dispensing device according to claim 1, wherein the cooling assembly comprises a fixed plate, the fixed plate is mounted on the bottom frame, the fixed plate is provided with a sliding slot, the fixed plate is slidably provided with a slider through the sliding slot, the slider is locked on the fixed plate by bolts, the slider is provided with a connecting plate, and the connecting plate is provided with a refrigerating module for cooling the adhesive hose.

4. The hot melt adhesive dispensing device according to claim 1, wherein the base is provided with an insertion slot, the base is provided with a bottom platform, the movable base is provided with an insertion connector inserted into the insertion slot, and the insertion connector is provided with a first positioning plate abutting against the base.

5. The hot melt adhesive dispensing device according to claim 4, wherein supporting rods are mounted on the base, a first guide rod is mounted on the supporting rods, a lifting plate is slidably mounted on the supporting rods, each supporting rod is sleeved with a first spring, one end of each first spring is connected with the lifting plate, and the other end of the first spring is connected with the first guide rod; and fixed rods are mounted on the lifting plate, a second guide rod is mounted on each fixed rod, a fastening plate for fastening the lug of the adhesive hose is slidably mounted on each second guide rod, each second guide rod is sleeved with a second spring, one end of each second spring is connected with the corresponding fastening plate, and the other end of the second spring is connected with the corresponding fixed rod, and pull rods for controlling the movement of the fastening plates are connected to the base.

6. The hot melt adhesive dispensing device according to claim 5, wherein sliding rods are slidably mounted on the base, ends of the sliding rods are provided with a pressing buckle, ends, away from the pressing buckle, of the sliding rods are provided with a pressing plate, each sliding rod is sleeved with a third spring, one end of each third spring is connected with the pressing plate, and the other end of the third spring is connected with the base, moving blocks are slidably mounted on the first guide rod, each moving block is hinged with a hinge rod, one end, away from the corresponding moving block, of each hinge rod is hinged with the pressing plate, and each pull rod is mounted on the corresponding moving block.

7. The hot melt adhesive dispensing device according to claim 4, wherein the insertion slot is a dovetail slot, and the insertion connector is a dovetail head.

8. The hot melt adhesive dispensing device according to claim 1, wherein one end, inserted into the adhesive hose, of the insertion rod is disposed in the shape of a ball head.

9. The hot melt adhesive dispensing device according to claim 1, wherein the insertion rod is provided with a sealing ring.

10. A hot melt adhesive dispensing process, completed by the hot melt adhesive dispensing device according to any one of claims 1-9, comprising the steps of:
mounting an adhesive hose, namely mounting the adhesive hose on a fixing assembly;
connecting the adhesive hose with an adhesive discharge assembly, namely forming an opening in a tail end of the adhesive hose, and connecting the adhesive discharge assembly into the adhesive hose from the tail end of the adhesive hose;
mounting a cooling assembly, adjusting a cooling position of the cooling assembly to the adhesive hose, and taking an area between the cooling position of the cooling assembly and the fixing assembly as a heating area; and
heating the adhesive hose to melt a hot melt adhesive to be discharged.
